(19) United States
(12) Patent Application Publication
(10) Pub. No.: US 2025/0085247 A1
(43) Pub. Date: Mar. 13, 2025

(54) Methods, Systems, and Devices for Modular Cartridge Testing and Assays

(71) Applicant: IDEXX Laboratories, Inc., Westbrook, ME (US)

(72) Inventors: Murthy VSN Yerramilli, Falmouth, ME (US); Wayne Antony Bell, Kennebunk, ME (US); Gerald Lee Beauregard, Stratham, NH (US)

(21) Appl. No.: 18/826,541

(22) Filed: Sep. 6, 2024

Related U.S. Application Data
(60) Provisional application No. 63/581,447, filed on Sep. 8, 2023.

(51) Int. Cl. G01N 27/07; G01N 27/74

(52) U.S. Cl. CPC G01N 27/07; G01N 27/745

(57) ABSTRACT

A method for method for analyzing a droplet on a surface of a module. The method includes: (i) receiving, via a port of a carrier interfaced with the module, a sample, wherein the carrier port is in fluid communication with a reservoir of the module; (ii) transporting, via a plurality of electrodes of the module, along a surface of the module, the droplet, wherein the droplet comprises a portion of the sample and a plurality of particles; (iii) immobilizing, at a location on the surface of the module, the droplet; and (iv) analyzing, while the droplet is immobilized at the location on the surface of the module, the droplet.

### FIELD OF THE DISCLOSURE

The present disclosure involves systems and methods for modular cartridges to transport, manipulate, and analyze a droplet comprising a plurality of particles on one or more surfaces of the cartridge. Namely, devices and methods of the disclosure allow for multi-configuration cartridges that provide a variety of tests and assays for one or more droplets to identify one or more parameters of the droplet and/or a component thereof.

### BACKGROUND

Assays (including immunoassays) and other analytical evaluations (e.g., polymerase chain reaction (PCR) tests) can be conducted on one or more portions of a sample utilizing a variety of different methods, including by utilizing a plurality of particles (e.g., paramagnetic, bar-coded beads) and other components of a droplet of the solution containing the sample to assist in performing the assays and other analytical evaluations.

Conventionally, these assays and analytical evaluations have been conducted on preconfigured and prefabricated testing platforms. One such platform are preconfigured cartridges that utilize a plurality of electrodes to transport individual droplets of a liquid on a surface of the cartridge along one or more paths defined by the plurality of electrodes on one or more surfaces of one or more materials, including a printed circuit board (PCB), semiconductor photolithography, conductive patterning on glass, conductive patterning on ceramic, and/or conductive patterning on plastic, among other possibilities. Such techniques are often referred to as electrowetting on dielectric (“EWOD”).

Typically, because these EWOD cartridges are preconfigured and prefabricated to interface with a particular reader and/or imaging platform, such cartridges are used for particular test or assay, and are often single use and disposed of after the test or assay is complete. Further, because such cartridges are often configured to interface with a particular reader and/or imaging platform, if the assay or testing portion of the cartridge (or underlying PCB) is smaller than the cartridge itself, then a substantial area of the cartridge (or underlying PCB) may go unutilized. Further, EWOD cartridges are often single use and are discarded after every test and/or assay is performed. Such single-use arrangements lead to waste, but also allow too much time to elapse between each test and/or assay, which in turn can lead to slower and more costly tests and/or assays, as well as impact the accuracy and precision of any test results therefrom. Accordingly, such single-use, preconfigured cartridges result in wasted resources and less accurate and precise testing results.

### SUMMARY

In an example, a modular cartridge is described. The example cartridge comprises a module comprising: (i) a plurality of electrodes; (ii) a surface for transporting and immobilizing a droplet, via the plurality of electrodes, on the surface of the module, wherein the droplet comprises a plurality of particles, and wherein the plurality of electrodes is configured to transport and immobilize the droplet on the surface of the module; and (iii) a reservoir. The example cartridge also comprises a carrier comprising: (i) a receiver, wherein the receiver is configured to mechanically interface with the module; and (ii) a port, wherein, when the carrier receiver is mechanically interfaced with the module, the carrier port is in fluid communication with the module reservoir.

In an example, a method is described for analyzing a droplet on a surface of a module. The method comprises: (i) receiving, via a port of a carrier interfaced with the module, a sample, wherein the carrier port is in fluid communication with a reservoir of the module; (ii) transporting, via a plurality of electrodes of the module, along a surface of the module, the droplet, wherein the droplet comprises a portion of the sample and a plurality of particles; (iii) immobilizing, at a location on the surface of the module, the droplet; and (iv) analyzing, while the droplet is immobilized at the location on the surface of the module, the droplet.

In another example, a non-transitory computer-readable medium is described, having stored thereon program instructions that, upon execution by a controller cause a controller to perform a set of operations. The set of operations comprises: (i) receiving, via a port of a carrier interfaced with a module, a sample, wherein the carrier port is in fluid communication with a reservoir of the module; (ii) transporting, via a plurality of electrodes of the module, along a surface of the module, a droplet comprising a portion of the sample and a plurality of particles; (iii) immobilizing, at a location on the surface of the module, the droplet; and (iv) analyzing, while the droplet is immobilized at the location on the surface of the module, the droplet at the location on the surface of the module.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2 illustrates an example cartridge.

FIG. 3 illustrates a module, according to an example embodiment.

FIG. 4a illustrates a cartridge, according to an example embodiment.

FIG. 4b illustrates the cartridge of FIG. 4a, according to an example embodiment.

FIG. 4c illustrates the cartridge of FIGS. 4a-4b, according to an example embodiment.

FIG. 5a illustrates a cartridge, according to an example embodiment.

FIG. 5b illustrates the cartridge of FIG. 5a, according to an example embodiment.

FIG. 6 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the disclosure is directed to devices, systems, and methods for multi-configuration and/or multi-use cartridges for manipulating droplets of a solution containing samples and a plurality of particles (e.g., one or more types of paramagnetic, bar-coded beads) containing one or more identifying features (such as a unique bar code, a responsive wavelength (e.g., in PCR testing), a color, a shape, an alphanumeric symbol, and/or the like). These particles include one or more of the following: microbeads, microparticles, micropellets, microwafers, microparticles containing one or more identifying features (such as a bar code, a responsive wavelength (e.g., in PCR testing), a color, a shape, an alphanumeric symbol, and/or the like), paramagnetic microparticles, paramagnetic microparticles containing one or more bar codes, and/or beads containing one or more bar codes. Moreover, the particles may be magnetic or paramagnetic. Particles suitable for use in the disclosure are capable of attachment to other substances such as derivatives, linker molecules, proteins, nucleic acids, or combinations thereof. The capability of the particles to be attached to other substances can result from the particle material as well as from any further surface modifications or functionalization of the particle. The particles can be functionalized or be capable of becoming functionalized in order to covalently or non-covalently attach proteins, nucleic acids, linker molecules or derivatives as described herein.

For example, the surface of these particles (e.g., paramagnetic, bar-coded beads), can be modified or functionalized with amine, biotin, streptavidin, avidin, protein A, sulfhydryl, hydroxyl and carboxyl. These particles may be spherical or other shapes, may be light transmissive and may be digitally coded such as for example, by an image that provides for high contrast and high signal-to-noise optical detection to facilitate identification of the bead. To the extent an image is present, the image may be implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), and the code represented by the image on the coded bead can be decoded. Various code patterns, such as circular, square, or other geometrical shapes, can be designed as long as they can be recognized by an optical decoder. Examples of these one or more types of particles may be found at: U.S. Pat. Nos. 7,745,091, 8,148,139, and 8,614,852.

Additionally or alternatively, these particles (e.g., paramagnetic, bar-coded beads) may comprise one or more materials, including one or more of the following: glass, polymers, polystyrene, latex, elemental metals, ceramics, metal composites, metal alloys, silicon, or of other support materials such as agarose, ceramics, glass, quartz, polyacrylamides, polymethyl methacrylates, carboxylate modified latex, melamine, and Sepharose, and/or one or more hybrids thereof. In particular, useful commercially available materials include carboxylate modified latex, cyanogen bromide activated Sepharose beads, fused silica particles, isothiocyanate glass, polystyrene, and carboxylate monodisperse microspheres. Furthermore, these particles also comprise one or more specific shapes, dimensions, and/or configurations and may be modified for one or more specific uses. For example, these particles (e.g., paramagnetic, bar-coded beads) may be a variety of sizes from about 0.1 microns to about 100 microns, for example about 0.1, 0.5, 1.0, 5, 10, 20, 30, 40 50, 60, 70, 80 90 or 100 microns. In a further aspect, these particles may be surface modified and/or functionalized with biomolecules for use in biochemical analysis.

The particles of the disclosure may be used in various homogenous, sandwich, competitive, or non-competitive assay formats to generate a signal that is related to the presence or amount of an analyte in a test sample. The term “analyte,” as used herein, generally refers to the substance, or set of substances in a sample that are detected and/or measured, either directly or indirectly. In various aspects the assays of the disclosure, examples include sandwich immunoassays that capture an analyte in a sample between a binding member (e.g., antibody) attached to the particles and a second binding member for the analyte that is associated with a label. In another example embodiment, the binding member on the particles may be an antigen (e.g., protein) that binds an antibody of interest in a patient sample in order to capture the antibody on the particle. The presence of the antibody can then be detected with a label conjugated to a second binding member specific for an antibody. The second binding member attached to the label may be the antigen conjugated to the label or the binding member may itself be an antibody (e.g., anti-species antibody) that is conjugated the label. In example embodiments, these characteristics may be referred to herein as a “unique identifying feature” and/or “parameter” of the particles and/or of droplet in which the particles reside. Other examples are possible. For example, the particles may also bind to a fluorescent tag or label, which may present a “unique identifying feature” and/or “parameter” of particles to which the fluorescent tag or label might bind and emit one or more responsive signals (e.g., a light signal) under one or more appropriate excitation stimuli (e.g., a fluorescent and/or ultraviolet lighting).

In another example embodiment, the testing protocols of the disclosure are assays, including competitive immunoassays for detection of antibody in the sample. A competitive immunoassay may be carried out in the following illustrative manner. A sample, from an animal's body fluid, potentially containing an antibody of interest that is specific for an antigen, is contacted with the antigen attached to the particles and with the anti-antigen antibody conjugated to a detectable label. The antibody of interest, present in the sample, competes with the antibody conjugated to a detectable label for binding with the antigen attached to the particles. The amount of the label associated with the particles can then be determined after separating unbound antibody and the label. The signal obtained is inversely related to the amount of antibody of interest present in the sample.

In an alternative example embodiment of a competitive a sample, an animal's body fluid, potentially containing an analyte, is contacted with the analyte conjugated to a detectable label and with an anti-analyte antibody attached to the particles. The antigen in the sample competes with analyte conjugated to the label for binding to the antibody attached the particles. The amount of the label associated with particles can then be determined after separating unbound antigen and label. The signal obtained is inversely related to the amount of analyte present in the sample.

Antibodies, antigens, and other binding members may be attached to the particles or to the label directly via covalent binding with or without a linker or may be attached through a separate pair of binding members as is well known (e.g., biotin:streptavidin, digoxigenin: anti-digoxiginen). In addition, while the examples herein reflect the use of immunoassays, the paramagnetic, bar-coded beads and/or particles and methods of the disclosure may be used in other receptor binding assays, including nucleic acid hybridization assays, that rely on immobilization of one or more assay components to a solid phase.

For example, if the assembled beads have magnetic or paramagnetic properties (e.g., if they contain paramagnetic, bar-coded beads), a magnet may be used to secure the assembled beads in a portion of the cartridge during one or more portions or a testing and/or assay protocol (e.g., while the assembled beads are being imaged). Other improvements may be realized.

For example, to help address these issues, a cartridge may utilize a plurality of electrodes that facilitate transportation of individual droplets of a liquid on a surface of the cartridge and/or one or more components thereof. To do so, in one example embodiment, the cartridge surface may comprise dielectric materials that transport individual droplets along one or more paths defined by the plurality of electrodes on one or more surfaces of one or more materials, including (PCB), semiconductor photolithography, conductive patterning on glass, conductive patterning on ceramic, and/or conductive patterning on plastic, among other possibilities. In example embodiments, the dielectric materials may comprise a hydrophobic material, layer, and/or coating disposed on the surface of the PCB and/or plurality of electrodes, the combination of which is referred to herein as the “dielectric surface” and/or a “path” or “paths” along the dielectric surface.

To date, such cartridges have involved a preconfigured, interwoven series of paths along the dielectric surface. Due to a number of factors, including the manufacturing costs of such cartridges, there exists a need to optimize cartridges to be able to execute various steps of testing protocols, but not include components that are extraneous to the desired testing protocols or waste any space on the cartridge and/or underlying components thereof (e.g., the underlying PCB). Further, because such cartridges are often configured to interface with a particular reader and/or imaging platform, if the assay or testing portion of the cartridge (or underlying PCB) is smaller than the cartridge itself, then a substantial area of the cartridge (or underlying PCB) may go unutilized. Further, because these EWOD cartridges are preconfigured and prefabricated to interface with a particular reader and/or imaging platform, such cartridges are preconfigured for a particular test or assay, and are often single use and disposed of after the test or assay is complete. Such single-use arrangements lead to waste, but also allow too much time to elapse between each test and/or assay, which in turn can lead to slower and more costly tests and/or assays, as well as impact the accuracy and precision of any test results therefrom. Thus, these preconfigured cartridges result in wasted resources and less accurate and precise testing results and there exists a need for a modular, multi-use, multi-configuration cartridge for performing a variety of testing protocols and/or assays over one or more samples.

Disclosed herein are devices, systems, and methods for a modular cartridge for use in a variety of systems and applications (including EWOD systems and applications) to perform one or more testing protocols (e.g., assays) using one or more particles and particle types (e.g., paramagnetic bar-coded beads). In example embodiments, by allowing a variety of testing modules to be interfaced with a preconfigured carrier (e.g., with the same footprint and configuration of an existing EWOD cartridge) multiple testing protocols and/or assays may be implemented in a single, multi-use, modular cartridge, thereby expanding and improving sample analysis, as well as associated testing protocols.

In some embodiments, a modular, multi-use cartridge is disclosed. In example embodiments, this modular cartridge includes two components, a module and a carrier. In some example embodiments, the module may comprise a plurality of electrodes that transport one or more droplets on the module surface, which can be controlled by a controller and/or other computing devices to create a programmable fluidic path which can be used in number of ways (e.g., to facilitate the performance of an assay and/or immunoassay). In one example, the module may include a reservoir or multiple reservoirs where one or more fluids and/or samples reside prior to undertaking a testing protocol and/or assay. In an example embodiment, the plurality of electrodes may be used to transport and/or otherwise manipulate a droplet to, from, and within the reservoir. Further, because the fluidic movements of the droplets are controlled by a controller and/or other computing device, and programmable, assay protocols and subparts thereof can be finely controlled to meet the needs of the desired testing protocol (e.g., an assay). Other examples are possible.

In a further aspect, the plurality of electrodes may be used to immobilize the droplets on the surface of the module. In one example, the plurality of electrodes may produce an electrical current that interacts with one or more of the components of the droplet to manipulate the droplet for one or more portions of the assay and/or testing protocol. For example, the plurality of electrodes may hold and flatten the droplet at a particular location on the surface of the module to facilitate and/or otherwise improve the imaging quality of the droplet. Other examples are possible.

In some embodiments, it is beneficial to align the module so that it can be utilized in connection with a particular reader and/or imaging device. To do so, in example embodiments, a carrier may be configured to receive one or more modules prior to the modules interfacing with the particular reader and/or imaging device. In some examples, the carrier may include one or more receivers configured to receive one or more particular module shapes and/or sizes. In some examples, these receivers may be a recess on a carrier that a particular module is inserted into prior to undertaking the desired testing protocol. In other examples, the receiver may include a recess on a first portion of a carrier (e.g., a bottom plate of a carrier) that that the module is laid into prior to a second portion of the carrier (e.g., a top plate of the carrier) being interfaced with the first portion to create the assembled carrier. In this regard, in example embodiments, the receiver may be specifically configured to mechanically interface with one or more modules and/or one or more types of modules. For example, a single carrier may have multiple receivers that allow multiple modules to be inserted into the single carrier to facilitate more than one testing and/or assay protocol to be performed via the single carrier. Other examples are possible.

For example, the carrier may also protect a droplet, components thereof (e.g., paramagnetic, bar-coded beads), and/or other materials residing on the surface of the module for one or more steps in an assay. To do so, in some embodiments, the carrier may be made of one or more materials that protect the components residing on the surface of the module, but still leave enough space on the cartridge surface for the droplet, components thereof (e.g., paramagnetic, bar-coded beads), and/or other assay components to be transported and/or immobilized on the module surface during the testing protocol. In some example embodiments, the carrier be made of plastic and/or other materials that do interact with the droplet and/or components thereof (e.g., paramagnetic, bar-coded beads), electrodes, or any other controller and/or other computing devices during the assay protocols and subparts thereof.

In an example embodiment, in addition to manipulating (e.g., transporting and/or immobilizing) the droplet on the surface of the module, various reagents, antibodies, antigens, and/or other components may also be controlled, mixed, transported, and/or immobilized on the surface of the module. In some example embodiments, the carrier may include one or more ports that, when a module is interfaced with the carrier (e.g., inserted into the carrier), the port is in fluid communication with one or more portions of the same module (e.g., a reservoir). In a further aspect, these ports may provide a sanitary, controlled communication path for a sample into the module for testing after the module has been interfaced with the carrier. In some examples, the carrier may contain multiple ports, each of which is in fluid communication with a respective reservoir of a respective module (e.g., to communicate a respective sample to each of the respective module reservoirs). In another example, the carrier may contain a single port that is in fluid communication with every reservoir of every module (e.g., to communicate a single sample to every module reservoir). In one example, a user may add a sample (e.g., a fecal sample, urine sample, blood sample, etc.) into a reservoir of the module via a port of the carrier, and then insert the assembled modular cartridge into a tabletop instrument/device, and allow the instrument/device to add and/or control other components (e.g., paramagnetic, bar-coded beads, solution, antibodies, etc.) on the module. In this regard, the user is able to analyze one or more components to provide one or more results to clinician, physician, and/or patient based on the same, all using the same sample, cartridge and instrument/device. Importantly, once the user inserts the assembled modular cartridge into the tabletop instrument device, some (or all) of the fluidics, manipulation of the components in the cartridge (including the plurality of electrodes paramagnetic, bar-coded beads), and eventual reading of these components are all automated, controlled, and finely-tuned by program instructions executing on a computing device, all of which may be accomplish without user interaction or control.

In example embodiments, using a programmable protocol, antibodies, antigens, and/or other components may be adhered onto one or more surfaces of paramagnetic, bar-coded beads (the “assembled beads”). In a further aspect, one or more analyses may be performed on the assembled beads (or other particles) on the surface of the module. In this regard, a user of the modular cartridge can perform multiple complicated, often multi-step protocols, which are often spread over several machines and devices at various stages of the multi-step protocols, using multiple modules interfaced with multiple receivers in a single cartridge and a single imaging instrument/device. In one example embodiment, a multiplex multiple analyte targets in a single reaction may be performed on a droplet on the surface of each of multiple modules interfaced into a single carrier, instead of using multiple devices (e.g., shaker plates, pipettes, vials, plates with multiple wells, plate readers, cameras, etc.).

In this regard, by combining the cartridge, EWOD, magnetic, and paramagnetic, bar-coded bead technologies, the concepts described herein provide disclosure for a compact, modular, multi-use, in clinic, instrument with multiplex capability. In an example embodiment, by leveraging these technologies, a platform is described that can have the same convenience as other tabletop devices, but with the increased menu of capabilities for laboratory testing and assay protocols, including a variety of modular multi-part assays (e.g., multiplex, Mpx lab tests), without the inconvenience and costs of the devices, instruments, and operators typically required for these tests and assays (e.g., liquid handling robots, plates, plate washers, and/or specialized plate readers). Further, in example embodiments, because multiple tests and assays may be completed on one or more small sample sizes (e.g., one or more droplets containing assembled paramagnetic, bar-coded beads), the present disclosure allows complex analysis (e.g., of multiple analytes) based on small volumes of samples, which is beneficial in instances where sample volume is an issue.

By doing so, several benefits are realized, including users (e.g., clinicians) having the same high throughput/multiplexing capability of the traditional technologies without the required overhead of user controlling or coordinating every step of the process or the multitude of separate devices and components required to accomplish the tests and/or assays. Time to result would also be improved, instead of sending samples to a lab and waiting for a prolonged period of time for results (sometimes several days), users could have results in a matter of minutes, and all while using a single sample on a single cartridge in connection with a single device. This improved time to result also improves the ability for a treating physician and/or patient to receive results in a more timely manner (e.g., results could be shared with the patient during the visit) and make more timely decisions based thereon.

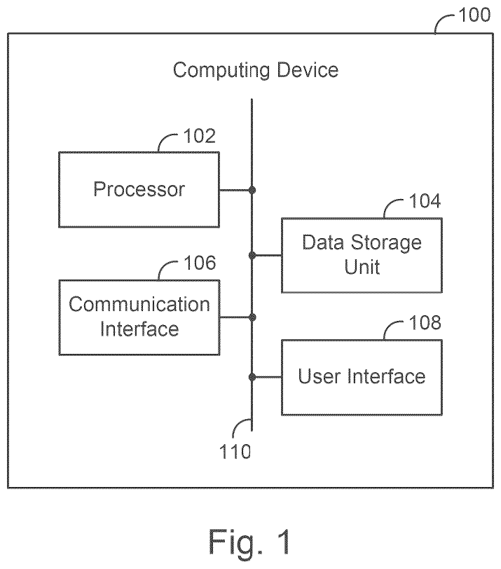

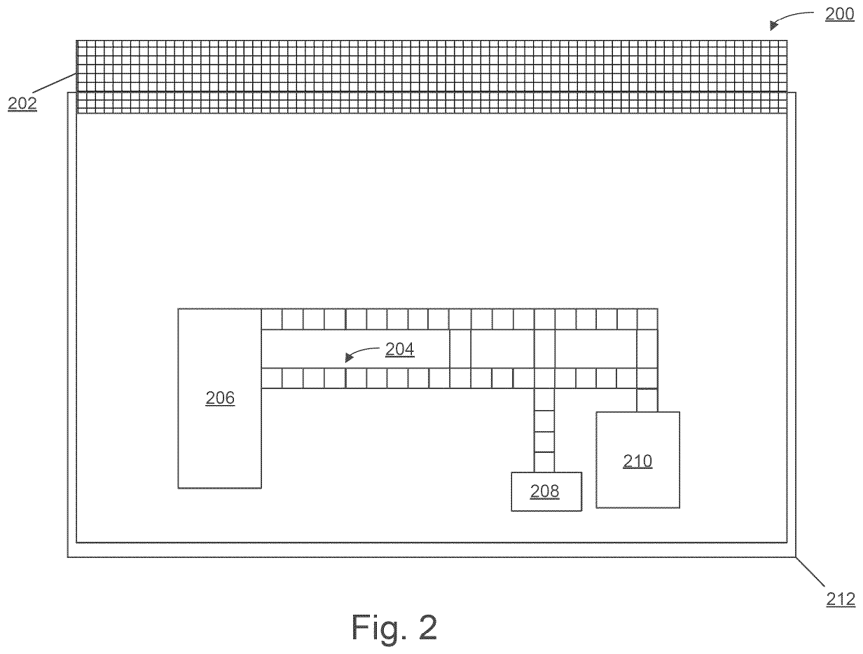

Referring now to the figures, FIG. 1 is a simplified block diagram of an example computing device 100 of a system (e.g., those illustrated in FIG. 2, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor) and/or a special-purpose processor (e.g., a digital signal processor (DSP)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIG. 2, an example cartridge of existing systems is disclosed. In FIG. 2, cartridge 200 includes electrical contacts 202 connected to the electrodes of path 204, sample reservoir 206, component reservoir 208, and a waste reservoir 210, all of which reside on the dielectric cartridge surface, according to an example embodiment. In this example embodiment, the electrodes along the illustrated paths and reservoirs on the dielectric cartridge surface facilitates transportation of a fluid droplet containing a plurality of particles (e.g., at least one paramagnetic, bar-coded bead) along the path 204 of dielectric cartridge surface, as well as all of the illustrated paths that connect all of these components in FIG. 2. In a further aspect, cartridge 200 may include a housing 212 that surrounds and/or otherwise protects some or all of the components of cartridge 200.

Further, as illustrated in FIG. 2, a substantial portion of the dielectric cartridge surface of cartridge 200 is unutilized, and therefore wasted, mechanically and systematically, as the cartridge is used in testing protocols and/or assays. Thus, although consistency in the overall size and configuration of the cartridge 200 is preferred so that cartridge 200 can be utilized in connection with existing readers and/or imaging devices, substantial improvement could be made to the utilization of the components and configuration of cartridge 200, and its implementation in testing and/or assay protocols.

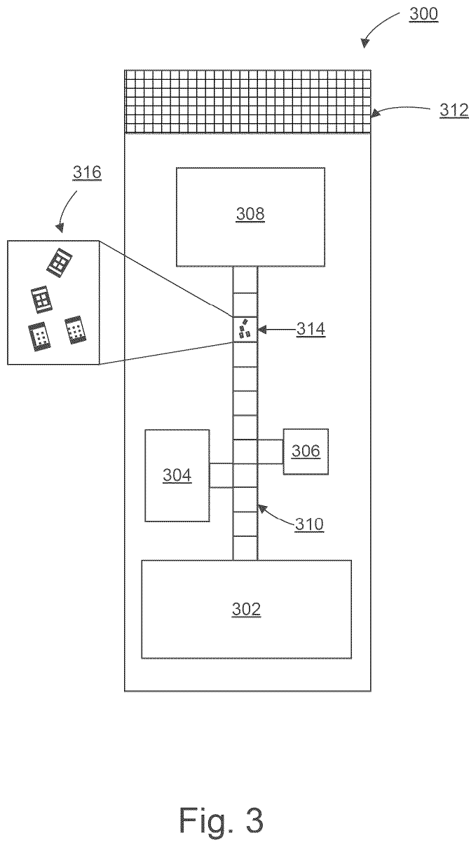

For example, now referring to FIG. 3, an example single-line module 300 is disclosed, which includes a sample reservoir 302, a solution reservoir 304, an assay component reservoir 306, and a waste reservoir 308, all of which reside on the dielectric surface of module 300, according to an example embodiment. In this example embodiment, a plurality of electrodes are disposed along various portions of the dielectric surface of module 300, including along the single substantially linear path 310 of electrodes that are connected to electrical contacts 312 and extend between sample reservoir 302 and waste reservoir 308, and the paths on the dielectric surface that lead to solution reservoir 304 and assay component reservoir 306. In a further aspect, the plurality of electrodes may be disposed under and/or around any of the illustrated sample reservoir 302, solution reservoir 304, assay component reservoir 306, waste reservoir 308, and/or other portions of module 300.

As noted above, this plurality of electrodes along the illustrated paths and reservoirs on the dielectric surface of module 300 facilitates transportation of a fluid droplet containing a plurality of particles (e.g., at least one paramagnetic, bar-coded bead) along the single substantially linear path 310 of the dielectric surface. For clarity, as illustrated in FIG. 3, the term “dielectric surface” as used in FIG. 3 includes the surfaces below the illustrated sample reservoir 302, solution reservoir 304, assay component reservoir 306, and waste reservoir 308, as well as all of the illustrated paths that connect all of these components in FIG. 3.

In examples, the module 300 and/or any components thereof may interact with a computing device, such as computing device 100. As described above, a computing device 100 can be implemented as a controller, and a user of the controller can use the controller to program and/or control module 300 and/or any components thereof. The module 300 and/or any components thereof may communicably coupled with a controller, such as computing device 100, and may communicate with the controller by way of a wired connection, a wireless connection, or a combination thereof. Further, as described above, a controller may be configured to control various aspects of the illustrated module 300 and testing protocols (e.g., assays) utilizing module 300 and/or any components thereof. Although various components and arrangements of these components are provided for explanatory purposes, and different shapes, amounts, and/or types of beads, particles, and/or components may be used in a variety of example embodiments.

In example embodiments, the controller can execute a program that cause one or more components of the module 300 to perform a series of events to by way of a non-transitory computer-readable medium having stored program instructions. These program instructions include, for example, applying voltage and/or current to a plurality of electrodes near (e.g., below) the dielectric materials of the dielectric surface of module 300 to transport one or more droplets (or components thereof) along the dielectric surface. In some examples, the plurality of electrodes may be used to transport one or more droplets between the illustrated components of FIG. 3 and/or manipulate the one or more droplets and/or components thereof at one more portions of the dielectric surface. For example, a controller may apply a direct current to the plurality of electrodes via electrical contacts 312 in a succession of on/off voltage/current bursts, which may result in the droplet alternating between an elongated form on the dielectric surface (when the voltage/current is applied to an electrode near the droplet) and a non-elongated form on the dielectric surface (when the voltage/current is not applied to an electrode near the droplet). In examples, this oscillation of on/off voltage/current bursts and the associated form the droplet takes during each event, may be useful for mixing and/or homogenizing the components throughout the droplet. Certain voltages/currents amplitudes and patterns, as well as electrode placement around the dielectric surface of the module may more effectively agitate the droplet to produce more accurate and consistent particle mixing and associated test results than other methods. In example embodiments, the plurality of electrodes may receive electrical current from a reader and/or other imaging devices via electrical contacts 312.

For example, if a direct current is applied to electrodes proximate to droplet containing paramagnetic, bar-coded beads, because of the paramagnetic properties of the beads, the beads may align with the direct current and stay stationary on the surface of the module. Alternatively, if an alternating current is applied to electrodes proximate to droplet containing paramagnetic, bar-coded beads, because of the paramagnetic properties of the beads, the beads may align with the direct current and alternate between two or more positions on the surface of the dielectric surface based on the alternating current. Other examples are possible and it should be appreciated that complex and novel fluidic functions can be performed because of the processor-controlled fluidics.

For example, the controller program instructions can include moving various fluids around the surface of the module and perform various aspects of a testing protocol (e.g., assay), all on the surface of the module and all in an automated (or largely automated) procedure.

In this regard, in example embodiments, the plurality of electrodes may transport a droplet containing paramagnetic, bar-coded beads along the single substantially linear path 310 of the dielectric surface of module 300. In examples, the paramagnetic, bar-coded beads may be introduced into a droplet, either in a liquid suspension or dried onto a surface of the module 300 and rehydrated. In one example, the paramagnetic, bar-coded beads may be suspended in buffer solution containing sucrose, removed from the suspension, and dried before being stored on a portion 314 of the single substantially linear path 310. In examples, the dried paramagnetic, bar-coded beads may be rehydrated with one or more solutions containing one or more components (e.g., reagents, sample, or both, among other possibilities) before being used in one or more aspects of a testing protocol (e.g., an assay). In example embodiments, once the paramagnetic, bar-coded beads are rehydrated and/or introduced into a fluidic droplet, the droplet containing paramagnetic, bar-coded beads may be transported from portion 314 to sample reservoir 302 to be mixed with a sample residing in sample reservoir (e.g., a fecal sample, urine sample, blood sample, etc.).

In other example embodiments, the dried paramagnetic, bar-coded beads may be stored in the sample reservoir 302 and rehydrated with solution from solution reservoir 304, liquid that accompanies the sample upon introduction to sample reservoir 302 (e.g., urine), or both, among other possibilities.

In a further aspect, in example embodiments, the plurality of electrodes may transport a droplet of assay components (e.g., containing antibodies, antigens, labels, reagents, and/or other binding members) from assay component reservoir 306 on the dielectric surface of module 300. In examples, these assay components may be introduced into a droplet, either in a liquid suspension or dried onto a surface of the module 300 and rehydrated (e.g., in component reservoir 306, on the path approximate to component reservoir 306, or both, among other possibilities). Either way, once the assay components are introduced into the droplet, the droplet containing assay components may be transported to sample reservoir 302 to be mixed with the sample and/or paramagnetic, bar-coded beads residing in sample reservoir.

In other example embodiments, one or more particular assay components (e.g., antibodies) may be dried and stored in the sample reservoir 302, perhaps with the dried paramagnetic, bar-coded beads, and rehydrated in the sample reservoir with solution from solution reservoir 304, liquid that accompanies the sample upon introduction to sample reservoir 302 (e.g., urine), or both, among other possibilities. In a further aspect, in this example embodiment, one or more additional assay components (e.g., reagents, fluorescent labels/tags, etc.) may be stored assay component reservoir 306 and transported on the dielectric surface to the sample reservoir 302 to be mixed with the one or more particular assay components, paramagnetic, bar-coded beads, one or more samples, and/or other components, among other possibilities.

Furthermore, although sample reservoir 302, solution reservoir 304, and assay component reservoir 306 are illustrated as single reservoirs in FIG. 3, it should be apparent to a person of ordinary skill in the art that any, some, or all of these reservoirs may comprise multiple, separate reservoirs, each of which may contain a particular particle, components, or combination thereof (e.g., dried paramagnetic, bar-coded beads and/or particular antibodies, antigens, labels, and/or other binding members). Additionally or alternatively, although specifically illustrated in FIG. 3, there may be multiple assay component reservoirs in module 300, each with their own associated assay component and/or path on the dielectric surface.

In example embodiments, a variety of techniques can be used facilitate the mixing of the sample, the paramagnetic, bar-coded beads, and the assay components in the sample reservoir 302. In some examples, a plurality of electrodes disposed near the sample reservoir 302 may be employed to circulate and/or otherwise manipulate the fluidics of the components in the sample reservoir 302, including the droplet containing paramagnetic, bar-coded beads, the sample (which may contain liquids), the assay components, and/or combinations thereof, among other possibilities. To do so, in example embodiments, the plurality of electrodes may receive electrical current from a reader and/or other imaging devices via electrical contacts 312. Other examples are possible.

For example, one or more magnets disposed near the sample reservoir 302 may be employed to immobilize the droplet containing paramagnetic, bar-coded beads, while the plurality of electrodes can be used in connection with the magnets to otherwise manipulate the fluidics of the other components in the sample reservoir 302, including the droplet containing paramagnetic, bar-coded beads, the sample (which may contain liquids), the assay components, and/or combination thereof, among other possibilities. For example, one or more mixing beads may also reside in the sample reservoir 302, which may be controlled by the magnets, the electrodes, or both to further facilitate mixing the components in the sample reservoir 302 at various mixing speeds, patterns, etc., all of which may be controlled by the controller executing program instructions controlling the components of the module 300.

In example embodiments, once the droplet containing paramagnetic, bar-coded beads, the sample, and/or other assay components is sufficiently mixed, all of these components may incubate in the sample reservoir 302 (e.g., to allow attachment of one or more assay components and/or components of the sample to attach to the paramagnetic, bar-coded beads). In example embodiments, once the incubation is complete, the paramagnetic, bar-coded beads and the attached sample and/or assay components (collectively, the “assembled beads”) may be immobilized in the sample reservoir 302 while the fluids in the sample reservoir 302 may be transported to waste reservoir 308 along the single substantially linear path 310 of the dielectric surface of module 300 (e.g., using a plurality of electrodes).

In other examples, this sequence of transporting the paramagnetic, bar-coded beads and/or the assembly components to the sample reservoir, mixing in the sample reservoir, and transporting solution to and from to the sample reservoir may be repeated a number of times and/or in different orders, depending on the requirements of the testing protocol.

Once the assembled beads are completed and ready for analysis, in examples, the assembled beads may be transported along single substantially linear path 310 of dielectric surface to a portion 314 of the single substantially linear path 310 for analysis. In example embodiments, the assembled beads may be transported via fluidic transportation from the sample reservoir 302 along the single substantially linear path 310 of dielectric surface using the plurality of electrodes, among other possibilities.

In examples, portion 314 of the single substantially linear path 310 of dielectric surface provides a predetermined location for a reader to conduct the testing (e.g., assay) on the assembled bead. In example embodiments, the reader may detect, shortly after the assembled bead is complete, an assay read signal corresponding to at least one of the assembled beads residing (and potentially immobilized) on the portion 314. In some example embodiments, this detection may occur within a predetermined time period after assembly is complete and by starting the assay read shortly after the conclusion of the assembly, the assay provides a more accurate result. In an example embodiment, an optics system reader may be employed to decode the individual bar codes of the paramagnetic, bar-coded beads. In other examples, a plurality of electrodes and/or one or more magnets may be used to manipulate the paramagnetic, bar-coded beads while reading other parameters of the droplet containing the assembled beads and/or the assembled beads themselves (e.g., by applying an ultraviolet light and reading the fluorescence of the assembled beads via a fluorophore detector). As illustrated in FIG. 3, exploded view 316 provides an example view of paramagnetic, bar-coded beads being read at the portion 314, and it should be appreciated that this analysis (e.g., reading) could occur at other portions of the module 300, including in the sample reservoir 302.

In a further aspect, although the mixing and analysis protocols have been discussed in connection with sample reservoir 302, it should be appreciated that these mixing protocols can occur in other parts of the illustrated module 300, including on the portion 314 of the single substantially linear path 310 of dielectric surface of module 300. Other examples are possible.

In a further aspect, as detailed in FIG. 3, by allowing bi-directional flow along a single, substantially linear path on the surface of the module, sample analysis and associated testing protocols are improved based on, at least, a more compact footprint and improved utilization of the dielectric surface of module 300, as well as improved time to analysis and multiple interactions between the sample and the beads during assembly based on the flow of components and/or the sample over the beads along the single, substantially linear path on the surface of the module 300.

Additionally, in some example embodiments, the one or more components of the module illustrated in FIG. 3, the controller illustrated in FIG. 1, and/or other components of the illustrated system may provide feedback to a user/operator, including a graphical representation of a detected parameter, a test result, and/or the like, via a user interface of the controller and/or the tabletop device to provide information to the user. Other examples are possible.

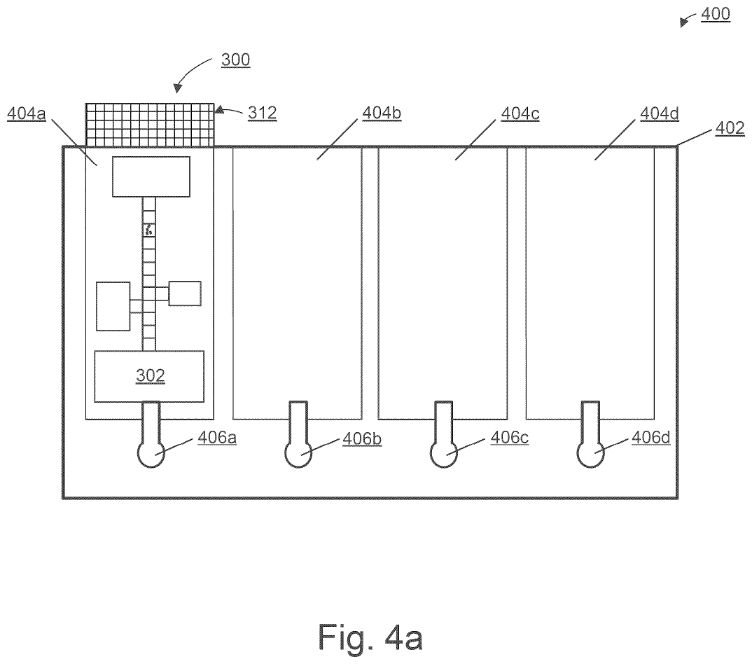

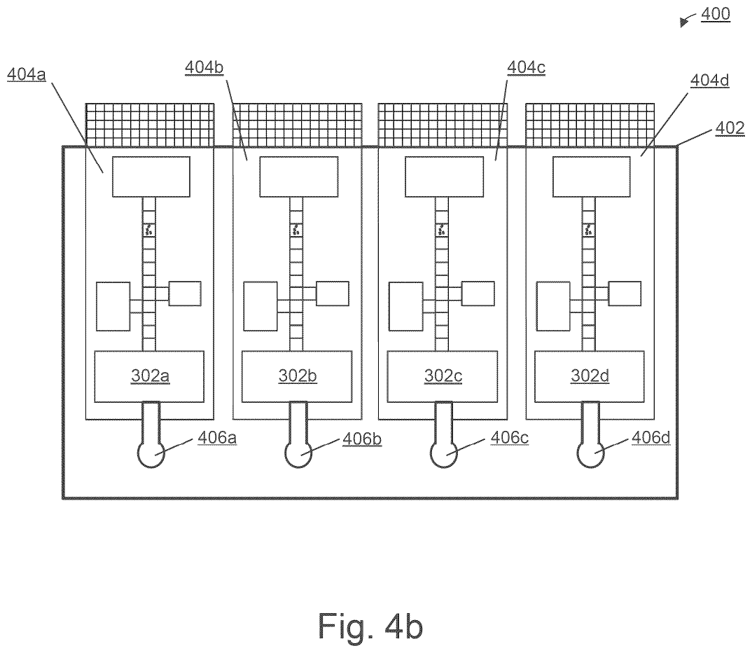

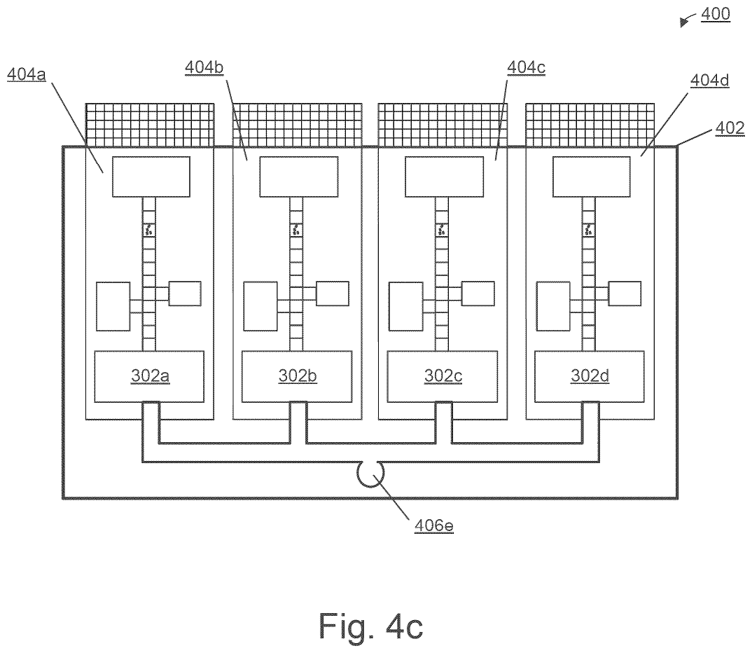

For example, now referring to FIG. 4a, a modular cartridge 400 is disclosed. Example modular cartridge 400 includes a module 300 (the module illustrated in FIG. 3) that includes, among other components, a sample reservoir 302 and electrodes that are connected to electrical contacts 312. As illustrated in FIG. 4a, modular cartridge 400 also includes a carrier 402 that includes a first receiver 404a, a second receiver 404b, a third receiver 404c, and a fourth receiver 404d, each of which are configured to interface with a module (such as module 300). Further, as also illustrated in FIG. 4a, carrier 402 includes a first port 406a, a second port 406b, a third port 406c, and a fourth port 406d, each of which is configured to provide a fluid communication path interface with a sample reservoir of a module (such as module 300) when the module is interfaced with the carrier. Further, although the first port 406a, second port 406b, third port 406c, and fourth port 406d are illustrated in FIG. 4a as being manufactured as part of carrier 402, it should be understood that one or more of these ports may be manufactured as part of the module itself. In example embodiments, carrier 402 may be manufactured such that when one or more modules are inserted into the carrier 402, one or more openings of the carrier 402 allow one or more of ports of a module to accept a sample. Other examples are possible.

In a further aspect, to interface with the one or more modules, carrier 402 may be configured to receive one or more modules prior to the modules interfacing with a particular reader and/or imaging device. As illustrated in FIG. 4a, carrier 402 may include four receivers configured to receive one or more of the particular module shape and size of module 300, which is beneficial to align module 300 so that it can be utilized in connection with a particular reader and/or imaging device. To do so, in example embodiments, any of the first receiver 404a, a second receiver 404b, a third receiver 404c, and a fourth receiver 404d may be a recess on carrier 402 that module 300 is inserted into prior to undertaking the desired testing protocol. In other examples, the first receiver 404a, a second receiver 404b, a third receiver 404c, and a fourth receiver 404d may be recesses on a first portion of a carrier (e.g., a bottom plate of a carrier) into which one or more modules (e.g., module 300) are placed. In some example embodiments, this first portion of carrier 402 may be sufficient to hold and alight module 300 during the testing protocol (i.e., acting as an alignment tray for module 300). However, in some embodiments, a second portion of the carrier (e.g., a top plate of the carrier) may be added to cover the one or more modules residing in the first portion of the carrier 402, and further stabilize and/or protect the components of module 300 during the testing protocol. In a further aspect, it should be appreciated that either or both of these portions may be referred to herein as the “carrier” and once the first portion is connected to (or otherwise interfaced with) the second portion, the combination of the portions may also be referred to herein as the “carrier” or the “assembled carrier.” Further, as illustrated in FIGS. 4a-4c, carrier 402 is approximately the same dimensions as cartridge 200 of FIG. 2. In this regard, modular cartridge 400 may be used with the same or similar reader and/or imaging device as cartridge 200, but provide a variety of testing protocols in a single carrier through its modular design (including the implementation of module 300). Other examples are possible.

For example, one or more of the first receiver 404a, a second receiver 404b, a third receiver 404c, and a fourth receiver 404d of carrier 402 may be configured to mechanically interface with one or more modules and/or one or more types of modules (e.g., module 300). As illustrated in FIG. 4a, a single carrier may have multiple receivers that allow multiple modules to be inserted into the single carrier via each of the receivers to facilitate more than one testing and/or assay protocol to be performed via the single carrier.

To do so, as illustrated in FIG. 4a, carrier 402 may include a first port 406a, a second port 406b, a third port 406c, and a fourth port 406d, each of which is configured to provide a fluid communication path to the sample reservoir of a module (such as module 300) when the module is interfaced with the carrier. In example embodiments, this fluid communication is provided to allow a user to insert a sample in a portion of the module (e.g., a sample reservoir) via the port of the carrier once the module is interfaced with the carrier. In other examples, this fluid communication allows for other types of liquids to be introduced to a portion of and/or the surface of the module to be utilized in one or more portions of the testing protocol (as further described above in connection with, at least, FIG. 3). In a further aspect, these ports may provide a sanitary, sealable, self-contained and controllable communication path for a sample into the module for testing after the module has been interfaced with the carrier, including one or more of the following: fecal sample, urine sample, blood sample, one or more solutions (e.g., a buffer solution), etc. Other examples are possible.

For example, other types of modules and/or other analytical evaluations may be integrated into modular cartridge 400. For example, one or more modules that are the same or different than module 300 may be inserted into one or more of the second receiver 404b, third receiver 404c, and/or fourth receiver 404d. For example, one or more modules that are different than module 300 may be placed into one or more of these receivers such that different or additional tests can be conducted on one or more portions of a sample utilizing a variety of different methods. In some example embodiments, these modules may include one or more of the following: blood coagulation testing modules, polymerase chain reaction (PCR) test modules, immunoassay modules, and/or imaging modules, among other possibilities. For example, in some example embodiments, these modules may include one or more of the following blood chemistry tests: SDMA, Total T4 (TT4), Bile Acids, C-reactive Protein (CRP), Progesterone, Fructosamine (FRU), and/or Phenobarbital (PHBR), among other possibilities. For example, in some example embodiments, these modules may include one or more of the following blood chemistry profile tests that measure one or more of the following: albumin (ALB), globulin (GLOB), ALB/GLOB, alkaline phosphatase (ALKP), alanine transaminase (ALT), amylase (AMYL), aspartate transaminase (AST), blood urea nitrogen (BUN), creatinine (CREA), BUN/CREA, calcium (Ca), cholesterol (CHOL), creatine kinase (CK), chloride (Cl), CRP, FRU, gamma-glutamyl transferase (GGT), GLOB, glucose (GLU), potassium (K), lactic acid (LAC), lactate dehydrogenase (LDH), lipase (LIPA), magnesium (Mg), sodium (Na), ammonia (NH₃), phosphate (PHOS), total bilirubin (TBIL), total protein (TP), triglycerides (TRIG), and/or uric acid (URIC), among other possibilities. Other examples are possible.

Turning to FIG. 4b, a fully assembled modular cartridge 400 is disclosed that includes four modules, each of which is interfaced with (e.g., inserted into) a respective first receiver 404a, second receiver 404b, third receiver 404c, and fourth receiver 404d. Further, as also illustrated in FIG. 4b, carrier 402 includes a first port 406a that provides a fluid communication path interface with a sample reservoir 302a of a module (such as module 300) when the module is interfaced with the carrier 402 (as well as a second port 406b that provides a fluid communication path interface with a sample reservoir 302b of a module, a third port 406c that provides a fluid communication path interface with a sample reservoir 302c of a module, and a fourth port 406d that provides a fluid communication path interface with a sample reservoir 302d of a module, when the respective module is interfaced with the respective receiver of the carrier). In example embodiments, different samples (or different portions of the same or similar samples) may be communicated into each sample reservoir of the modular cartridge 400 and four separate testing protocols (e.g., assays) may be conducted on four separate samples, all on the same carrier via four different modules. Other examples are possible.

For example, turning to FIG. 4c, a fully assembled modular cartridge 400 is disclosed that includes four modules, each of which is interfaced with (e.g., inserted into) a respective first receiver 404a, second receiver 404b, third receiver 404c, and fourth receiver 404d. Further, as also illustrated in FIG. 4c, carrier 402 includes a single port 406e that provides fluid communication paths that interface with each sample reservoir of each module when each of the modules is interfaced with the carrier 402. In an example embodiment, single port 406e provides a fluid communication path interface with each of sample reservoir 302a, sample reservoir 302b, sample reservoir 302c, and sample reservoir 302d when the respective module is interfaced with the respective receiver of the carrier). In example embodiments, a single sample may be communicated into each sample reservoir of the modular cartridge 400 and four separate testing protocols (e.g., assays) may be conducted on the same sample, on the same carrier via four different modules. Other examples are possible.

In the illustrated examples of FIG. 4a-4c, a user may add a sample (e.g., a fecal sample, urine sample, blood sample, etc.) into a reservoir of the module via one or more illustrated ports of the carrier 402, and then insert the assembled modular cartridge 400 into a tabletop instrument/device, and allow the instrument/device to add and/or control other components (e.g., paramagnetic, bar-coded beads, solution, antibodies, etc.) on one or more of the modules. In this regard, the user is able to analyze one or more samples on the same cartridge using separate testing protocol modules to provide a plurality of results to clinician, physician, and/or patient based on the same, all using the same sample, cartridge and instrument/device. Other examples are possible.

Further, in the illustrated examples of FIG. 4a-4c, one or more components of the modular cartridge 400 may be assembled by a user, prior to the user receiving the modular cartridge (e.g., assembled during manufacturing), or some combination of the two, among other possibilities. For example, in the illustrated examples of FIG. 4a-4c, the user may receive carrier 402 and integrate any combination of modules at his/her discretion prior to adding a sample (e.g., a fecal sample, urine sample, blood sample, etc.) and inserting the assembled modular cartridge 400 into a tabletop instrument/device for analysis. In this regard, the user is able to dynamically analyze any number of samples in a variety of testing protocols on the same cartridge using separate testing protocol modules. Additionally or alternatively, in the illustrated examples of FIG. 4a-4c, the user may order carrier 402 to be manufactured and assembled in any combination of modules at his/her discretion prior to receiving the assembled cartridge 400. In this regard, the user is able to predetermine and tailor a variety of testing protocols on the same cartridge using separate testing protocol modules prior to receiving the assembled cartridge 400. Additionally or alternatively, in the illustrated examples of FIG. 4a-4c, the user may order carrier 402 to be manufactured and partially assembled in any combination of modules so that some modules are integrated into the carrier 402 prior to receipt (e.g., first receiver 404a and second receiver 404b contain module 300), while other receivers remain open for the user to integrate any combination of modules at his/her discretion (e.g., third receiver 404c and fourth receiver 404d are open for other modules) prior to adding a sample and inserting the assembled modular cartridge 400 into a tabletop instrument/device for analysis. In this regard, the user is able to order partially assembled cartridges and then tailor one or more additional testing protocols on the same cartridge using separate testing protocol modules after receiving the partially assembled cartridge. Other examples are possible.

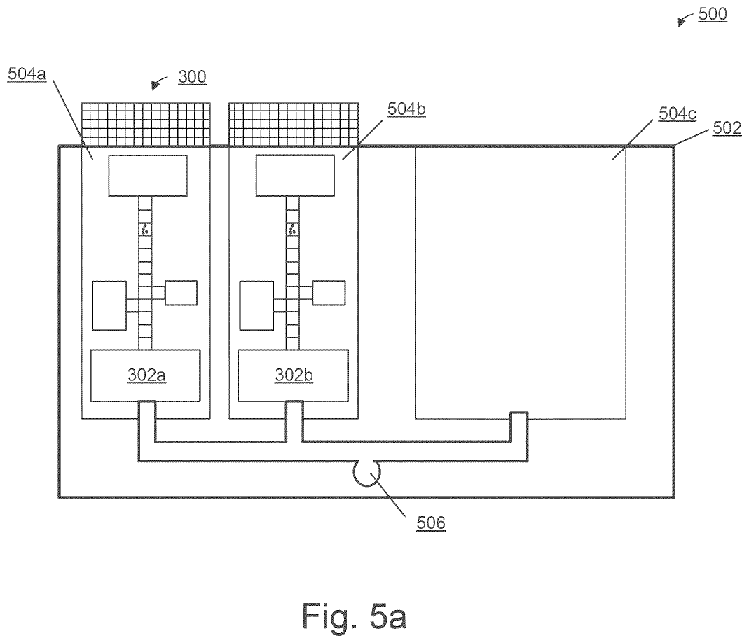

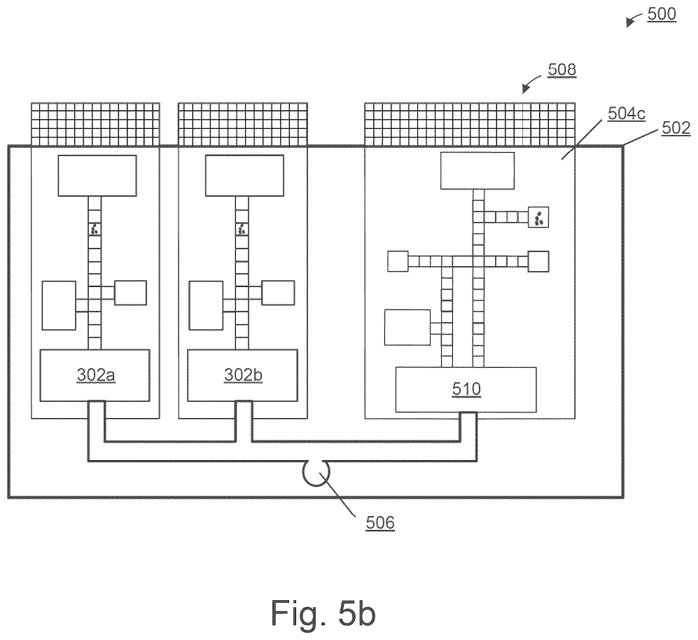

For example, now referring to FIG. 5a, a modular cartridge 500 is disclosed. Example modular cartridge 400 includes two modules 300 (the same modules illustrated in FIGS. 3 and 4a-4c) that include, among other components, sample reservoirs 302a and 302b, respectively. As illustrated in FIG. 5a, modular cartridge 500 also includes a carrier 502 that includes a first receiver 504a (interfaced with a first module 300), a second receiver 404b interfaced with a second module 300), and a third receiver 404c, which is configured for a module of different dimensions and/or configuration than module 300. Further, as also illustrated in FIG. 5a, carrier 502 includes a single port 506 configured to provide a fluid communication path interface with a sample reservoir of each interfaced module (such as module sample reservoir 302a) when the module is interfaced with the carrier.

In a further aspect, as illustrated in FIG. 5a, carrier 502 may include two receivers configured to receive a particular module shape and size (size and shape of module 300) and another receiver that is configured to receive another particular module shape and size, but all of which is beneficial to align the interfaced modules so that the assembled cartridge and underlying modules can be utilized in connection with a particular reader and/or imaging device. In some examples, the first receiver 504a, the second receiver 504b, and/or the third receiver 504c, may be recesses on a first portion of a carrier (e.g., a bottom plate of a carrier) into which one or more modules (e.g., module 300) are placed. In some embodiments, a second portion of the carrier (e.g., a top plate of the carrier) may be added to cover the one or more modules residing in the first portion of the carrier 502, and further stabilize and/or protect the components of the modules during the testing protocol. In a further aspect, it should be appreciated that either, some, or all of these illustrated receivers may be configured in a variety of ways, depending on the types of modules to be implemented and/or the testing protocols to be undertaken based on the same.

For example, other types of modules and/or other analytical evaluations may be integrated into modular cartridge 500. For example, one or more modules that are the same or different than module 300 may be inserted into the third receiver 504. For example, one or more modules that are different than module 300 may be placed into one or more of these receivers such that different or additional tests can be conducted on one or more portions of a sample utilizing a variety of different methods. In some example embodiments, these modules may include one or more of the following: blood coagulation testing modules, polymerase chain reaction (PCR) test modules, immunoassay modules, and/or imaging modules, among other possibilities. For example, in some example embodiments, these modules may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these modules may include one or more of the following blood chemistry profile tests that measure one or more of the following: ALB, ALB/GLOB, ALKP, ALT, AMYL, AST, BUN, BUN/CREA, Ca, CHOL, CK, Cl, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

Further, as illustrated in FIGS. 5a-5b, carrier 502 is approximately the same dimensions as cartridge 200 of FIG. 2 and cartridge 400 of FIGS. 4a-4c. In this regard, modular cartridge 500 may be used with the same or similar reader and/or imaging device as cartridges 200 and 400, but provide a variety of testing protocols in a single carrier through its modular design (including the implementation of module 300 and other types of modules in the same carrier). Other examples are possible.

For example, one or more of the first receiver 504a, a second receiver 504b, a third receiver 504c may be configured to mechanically interface with one or more modules and/or one or more types of modules (e.g., module 300 and/or other types of modules). As illustrated in FIG. 4a, a single carrier may have multiple receivers that allow multiple modules to be inserted into the single carrier via each of the receivers to facilitate more than one testing and/or assay protocol to be performed via the single carrier. To do so, as illustrated in FIG. 5b, a fully assembled modular cartridge 500 is disclosed that includes three modules, each of which is interfaced with (e.g., inserted into) a respective first receiver 504a, second receiver 504b, and third receiver 504c (interfaced with a larger module 508 with its respective sample reservoir 510). Further, as also illustrated in FIG. 5b, carrier 502 includes a single port 506 that provides fluid communication paths that interface with each sample reservoir of each module when each of the modules is interfaced with the carrier 502. In an example embodiment, single port 506 provides a fluid communication path interface with each of sample reservoir 302a, sample reservoir 302b, and sample reservoir 510 when the respective module is interfaced with the respective receiver of the carrier). In example embodiments, as illustrated in FIG. 5b, a single sample may be communicated into each sample reservoir of the modular cartridge 500 and three separate testing protocols (e.g., assays) may be conducted on the same sample, on the same carrier via three different modules. Other examples are possible.

For example, in the illustrated examples of FIG. 5a-5b, one or more components of the modular cartridge 500 may be assembled by a user, prior to the user receiving the modular cartridge (e.g., assembled during manufacturing), or some combination of the two, among other possibilities. For example, in the illustrated examples of FIG. 5a-5b, the user may receive carrier 502 and integrate any combination of modules at his/her discretion. In this regard, the user is able to dynamically analyze any number of samples in a variety of testing protocols on the same cartridge using separate testing protocol modules. Additionally or alternatively, in the illustrated examples of FIG. 5a-5b, the user may order carrier 502 to be manufactured and assembled in any combination of modules at his/her discretion prior to receiving the assembled cartridge 500. In this regard, the user is able to predetermine and tailor a variety of testing protocols on the same cartridge using separate testing protocol modules prior to receiving the assembled cartridge 500. Additionally or alternatively, in the illustrated examples of FIG. 5a-5b, the user may order carrier 502 to be manufactured and partially assembled so that some modules are integrated into the carrier 502 prior to receipt (e.g., first receiver 504a and second receiver 504b contain module 300), while other receivers remain open for the user to integrate any combination of modules at his/her discretion (e.g., third receiver 504c are open for other modules). In this regard, the user is able to order partially assembled cartridges and then tailor one or more additional testing protocols on the same cartridge using separate testing protocol modules after receiving the partially assembled cartridge. Other examples are possible.

Additionally, in some example embodiments, one or more components of the cartridge illustrated in FIGS. 4a-4c and 5a-5b and/or an associated reader, imaging device, and/or controller of the illustrated systems may provide feedback to a user/operator, including a graphical representation of a detected parameter, a test result, and/or the like, via a user interface of the controller and/or the tabletop device to provide information to the user. Other examples are possible.

### EXAMPLE METHODS AND ASPECTS

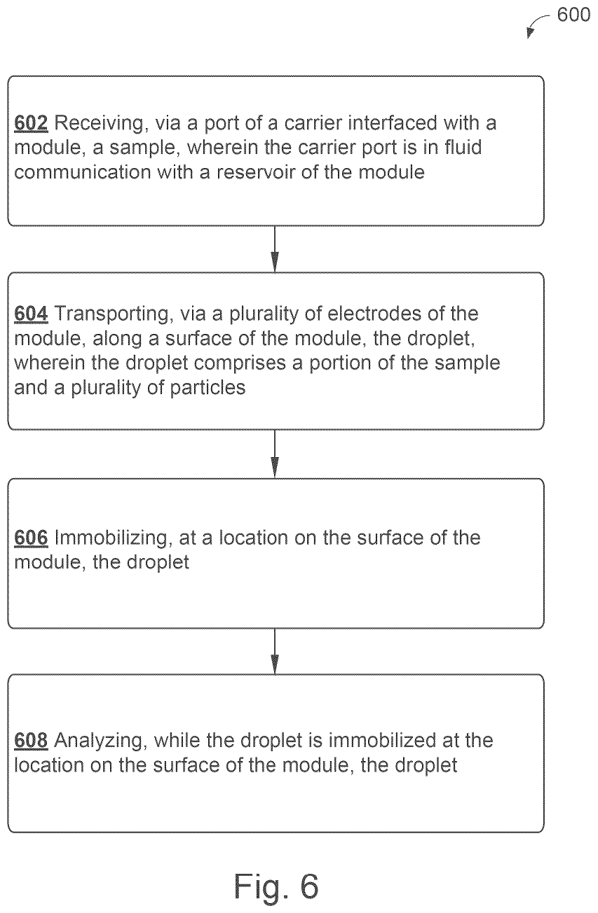

Now referring to FIG. 6, an example method of analyzing a droplet on a surface of a module is disclosed.

Method 600 shown in FIG. 6 presents an example of a method that could be used with the components shown in FIGS. 1-5b, for example. Further, devices or systems may be used or configured to perform logical functions presented in FIG. 6. In other examples, components of the devices and/or systems may be arranged to be adapted to, capable of, or suited for performing the functions, such as when operated in a specific manner. Method 600 may include one or more operations, functions, or actions as illustrated by one or more of blocks 602-508. Although the blocks are illustrated in a sequential order, these blocks may also be performed in parallel, and/or in a different order than those described herein.

Also, the various blocks may be combined into fewer blocks, divided into additional blocks, and/or removed based upon the desired implementation.

At block 602, method 600 includes receiving, via a port of a carrier interfaced with the module, a sample, wherein the carrier port is in fluid communication with a reservoir of the module.

In some example embodiments, the module comprises multiple modules, and wherein the carrier is interfaced with the multiple modules, and wherein receiving the sample comprises receiving, via the port of the carrier, a sample, and wherein the carrier port is in fluid communication with a reservoir of each of the multiple modules. In some example embodiments, the module comprises multiple modules, and wherein the carrier is interfaced with the multiple modules, and wherein the carrier comprises multiple ports, and wherein receiving the sample comprises receiving, via each of the multiple ports of the carrier, a sample, and wherein each of the multiple carrier ports is in fluid communication with a respective reservoir of each of the multiple modules.

At block 604, method 600 includes transporting, via a plurality of electrodes of the module, along a surface of the module, the droplet, wherein the droplet comprises a portion of the sample and a plurality of particles. In some example embodiments, the at least one paramagnetic, bar-coded bead of the droplet comprises at least one paramagnetic, bar-coded bead. In some example embodiments, the at least one paramagnetic, bar-coded bead of the droplet comprises one or more unique bar codes. In other examples, the at least one paramagnetic, bar-coded bead of the droplet comprises at least one non-spherical, paramagnetic, bar-coded bead. In some examples, the at least one paramagnetic, bar-coded bead of the droplet is between approximately 0.1 and 100 microns in size.

In some examples, the module comprises a dielectric material, and transporting, via a plurality of electrodes of the cartridge, the droplet along the surface of the module comprises applying an electric current to the electrodes of the module. In some examples, the electrical current comprises a direct electric current. In some examples, the electrical current comprises an alternating electric current.

At block 606, method 600 involves immobilizing, at a location on the surface of the module, the droplet.

At block 608, method 600 involves analyzing, while the droplet is immobilized at the location on the surface of the module, the droplet.

In some examples, analyzing the droplet at one or more locations along the surface of the module comprises performing one or more assay procedures on the droplet at the one or more locations on the surface of the module and wherein, during the one or more assay procedures, determining a parameter of the droplet. In some examples, determining a parameter of the droplet comprises identifying a particular feature of the plurality of particles.

In some examples, analyzing the droplet at one or more locations on the surface of the module comprises generating an image of the droplet at the one or more locations on the surface of the module, wherein the image comprises an image of the plurality of particles and, based on the generated image, determining a parameter of the droplet. In some examples, determining a parameter of the droplet comprises comparing the generated image of the droplet to a previously generated image of the droplet. In some examples, analyzing the droplet further comprises, while generating an image of the droplet at the one or more locations on the surface of the module, applying an ultraviolet light to the droplet. In some examples, analyzing the droplet comprises generating a composite image of the droplet on the surface of the module, wherein the composite image comprises a plurality of images of the at least one paramagnetic, bar-coded bead of the droplet and, based on the generated composite image, determining a parameter of the droplet. In some examples, the method 600 includes transmitting instructions that cause a graphical user interface to display a graphical representation of the determined parameter of the droplet.

In some examples, analyzing the droplet at one or more locations on the surface of the module comprises performing a plurality of assay procedures on the droplet at the one or more locations on the surface of the module, and wherein, during the one or more assay procedures, determining a presence of one or more analytes adhered to the at least one paramagnetic, barcoded bead of the droplet.

In one aspect, a non-transitory computer-readable medium, having stored thereon program instructions that, upon execution by a controller, cause a controller to perform a set of operations comprising (i) receiving, via a port of a carrier interfaced with a module, a sample, wherein the carrier port is in fluid communication with a reservoir of the module; (ii) transporting, via a plurality of electrodes of the module, along a surface of the module, a droplet comprising a portion of the sample and a plurality of particles; (iii) immobilizing, at a location on the surface of the module, the droplet; and (iv) analyzing, while the droplet is immobilized at the location on the surface of the module, the droplet at the location on the surface of the module, is disclosed.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A modular cartridge comprising:
a module comprising:
a plurality of electrodes;
a surface for transporting and immobilizing a droplet, via the plurality of electrodes, on the surface of the module, wherein the droplet comprises a plurality of particles, and wherein the plurality of electrodes is configured to transport and immobilize the droplet on the surface of the module; and
a reservoir; and
a carrier comprising:
a receiver, wherein the receiver is configured to mechanically interface with the module; and
a port, wherein, when the carrier receiver is mechanically interfaced with the module, the carrier port is in fluid communication with the module reservoir.

2. The cartridge of claim 1, wherein the plurality of particles comprises at least one paramagnetic, bar-coded bead.

3. The cartridge of claim 2, wherein the at least one paramagnetic, bar-coded bead comprises one or more unique bar codes.

4. The cartridge of claim 2, wherein the at least one paramagnetic, bar-coded bead comprises at least one non-spherical, paramagnetic, bar-coded bead.

5. The cartridge of claim 2, wherein the at least one paramagnetic, bar-coded bead is between approximately 0.1 to 100 microns in size.

6. The cartridge of claim 1, wherein the surface of the module comprises a dielectric material, and wherein transporting, via a plurality of electrodes of the module, the droplet on the surface of the module comprises applying an electric current to the electrodes of the module.

7. The cartridge of claim 6, wherein the electric current comprises a direct electric current.

8. The cartridge of claim 6, wherein the electric current comprises an alternating electric current.

9. The cartridge of claim 1, wherein reservoir of the module comprises a sample reservoir.

10. The cartridge of claim 1, wherein the cartridge further comprises:
a second module, wherein the second module comprises:
a second plurality of electrodes;
a second surface for transporting and immobilizing a droplet, via the plurality of electrodes, on the surface of the module, wherein the droplet comprises a plurality of particles, and wherein the plurality of electrodes is configured to transport and immobilize the droplet on the surface of the module; and
a second reservoir; and
wherein the carrier further comprises:
a second receiver, wherein the second receiver is configured to mechanically interface with the second module; and
a second port, wherein, when the second carrier receiver is mechanically interfaced with the second module, the second carrier port is in fluid communication with the second module reservoir.

11. The cartridge of claim 10, wherein the module and the second module are a same type of module.

12. The cartridge of claim 10, wherein the module and the second module are different types of modules.

13. The cartridge of claim 1, wherein the cartridge further comprises:
a second module, wherein the second module comprise:
a second plurality of electrodes;
a second surface for transporting and immobilizing a droplet, via the plurality of electrodes, on the surface of the module, wherein the droplet comprises a plurality of particles, and wherein the plurality of electrodes is configured to transport and immobilize the droplet on the surface of the module; and
a second reservoir; and
wherein the carrier further comprises:
a second receiver, wherein the second receiver is configured to mechanically interface with the second module, and wherein, when the second carrier receiver is mechanically interfaced with the second module, the carrier port is in fluid communication with the second module reservoir.

14. The cartridge of claim 13, wherein the module and the second module are a same type of module.

15. The cartridge of claim 13, wherein the module and the second module are different types of modules.

16. A method for analyzing a droplet on a surface of a module, the method comprising:
receiving, via a port of a carrier interfaced with the module, a sample, wherein the carrier port is in fluid communication with a reservoir of the module;
transporting, via a plurality of electrodes of the module, along a surface of the module, the droplet, wherein the droplet comprises a portion of the sample and a plurality of particles;
immobilizing, at a location on the surface of the module, the droplet; and
analyzing, while the droplet is immobilized at the location on the surface of the module, the droplet.

17. The method of claim 16, wherein the module comprises multiple modules, and wherein the carrier is interfaced with the multiple modules, and wherein receiving the sample comprises receiving, via the port of the carrier, a sample, and wherein the carrier port is in fluid communication with a reservoir of each of the multiple modules.

18. The method of claim 16, wherein the module comprises multiple modules, and wherein the carrier is interfaced with the multiple modules, and wherein the carrier comprises multiple ports, and wherein receiving the sample comprises receiving, via each of the multiple ports of the carrier, a sample, and wherein each of the multiple carrier ports is in fluid communication with a respective reservoir of each of the multiple modules.

19. The method of claim 16, wherein analyzing the droplet at the location on the surface of the module comprises performing one or more assay procedures on the droplet at the location on the surface of the module, and wherein, during the one or more assay procedures, determining a parameter of the droplet.

20. The method of claim 19, wherein determining a parameter of the droplet comprises identifying a particular feature of the plurality of particles.

21. The method of claim 16, wherein the plurality of particles comprises at least one paramagnetic, bar-coded bead.

22. The method of claim 21, wherein the at least one paramagnetic, bar-coded bead comprises one or more unique bar codes.

23. The method of claim 21, wherein the at least one paramagnetic, bar-coded bead comprises at least one non-spherical, paramagnetic, bar-coded bead.

24. The method of claim 21, wherein the at least one paramagnetic, bar-coded bead is between approximately 0.1 to 100 microns in size.

25. The method of claim 21, wherein the surface of the module comprises a dielectric material, and wherein transporting, via a plurality of electrodes of the module, the droplet on the surface of the module comprises applying an electric current to the electrodes of the module.

26. The method of claim 25, wherein the electric current comprises a direct electric current.

27. The method of claim 25, wherein the electric current comprises an alternating electric current.

28. A non-transitory computer-readable medium, having stored thereon program instructions that, upon execution by a controller, cause a controller to perform a set of operations comprising:
receiving, via a port of a carrier interfaced with a module, a sample, wherein the carrier port is in fluid communication with a reservoir of the module;
transporting, via a plurality of electrodes of the module, along a surface of the module, a droplet comprising a portion of the sample and a plurality of particles;
immobilizing, at a location on the surface of the module, the droplet; and
analyzing, while the droplet is immobilized at the location on the surface of the module, the droplet at the location on the surface of the module.
